(19) United States
(12) Patent Application Publication
(10) Pub. No.: US 2007/0236623 A1
(43) Pub. Date: Oct. 11, 2007

(54) Array substrate for liquid crystal display device and method of fabricating the same

(76) Inventors: Jae-Seok Heo, Gunpo-si (KR); Woong-Gi Jun, Annyang-si (KR); Gee-Sung Chae, Incheon (KR)

Correspondence Address: MCKENNA LONG & ALDRIDGE LLP;Song K. Jung, 1900 K Street, N.W., Washington, DC, 20006, US

(21) Appl. No.: 11/606,944

(22) Filed: Dec. 1, 2006

(30) Foreign Application Priority Data
Apr. 7, 2006 (KR) 2006-0031712

(51) Int. Cl. G02F 1/136

(52) U.S. Cl. 349/42

(57) ABSTRACT

An array substrate for a liquid crystal display device, including: a substrate; a gate electrode on the substrate; and a gate insulating layer including an organic matrix of an organic material and an additive that increases a dielectric constant of the gate insulating layer.

This application claims the benefit of Korean Patent Application No. 2006-0031712, filed on Apr. 7, 2006, which is hereby incorporated by reference in its entirety for all purposes as if fully set forth herein.

### BACKGROUND OF THE INVENTION

1. Field of the Invention

The present invention relates to an array substrate for an LCD device including a gate insulating layer having a high dielectric constant and a method of fabricating the array substrate.

2. Discussion of the Related Art

Liquid crystal display (LCD) devices are widely used in televisions and as monitors for notebook and desktop computers because of their high resolution, high contrast ratio, color rendering capability and superior performance for displaying moving images. An LCD device relies on the optical anisotropy and polarizing properties of liquid crystal to produce an image. In addition, an LCD device includes a liquid crystal panel including two substrates and a liquid crystal layer between the two substrates. An electric field generated between the two substrates adjusts an alignment direction of liquid crystal molecules in the liquid crystal layer to produce differences in transmittance, thereby displaying images.

FIG. 1 is an exploded perspective view showing a liquid crystal display device according to the related art. In FIG. 1, a liquid crystal display (LCD) device 11 includes a first substrate 22, a second substrate 5 and a liquid crystal layer 14 between the first and second substrates 22 and 5. A gate line 12 and a data line 24 are formed on the first substrate 22. The gate line 12 crosses the data line 24 to define a pixel region “P.” A thin film transistor (TFT) “T” is connected to the gate line 12 and the data line 24. The TFT “T” includes a gate electrode 30, a semiconductor layer 32, a source electrode 34 and a drain electrode 36. A pixel electrode 17 in the pixel region “P” is connected to the drain electrode 36.

A black matrix 6 is formed on the second substrate 5 and a color filter layer 7 including red, green and blue color filters 7a, 7b and 7c is formed on the black matrix 6. In addition, a common electrode 18 is formed on the color filter layer 7. The first and second substrates 22 and 5 are attached to each other using a seal pattern (not shown) at a boundary of the first and second substrates 22 and 5. The gap distance between the first and second substrates 22 and 5 is kept by a spacer between the first and second substrates 22 and 5. After the first and second substrates 22 and 5 are attached, liquid crystal materials are injected into the gap between the first and second substrates 22 and 5 through an injection hole, and the injection hole is sealed after the injection step.

When signals are applied to the pixel electrode 17 and the common electrode 18, an electric field is generated between the pixel electrode 17 and the common electrode 18 and liquid crystal molecules in the liquid crystal layer 14 are re-aligned along the electric field. As a result, light from a backlight unit (not shown) under the first substrate 22 passes through or is blocked by the liquid crystal layer 14, thereby the LCD device 11 displays images.

FIG. 2 is an equivalent circuit diagram representing a liquid crystal display device according to the related art. In FIG. 2, an LCD device includes a gate line 12 and a data line 24. The gate line 12 and the data line 24 cross each other to define a pixel region “P.” A switching element “S” such as a thin film transistor is disposed in each pixel region “P” and adjusts a voltage application to a liquid crystal capacitor “LC.” A gate driving circuit 40 and a data driving circuit 42 are disposed at two adjacent sides of a liquid crystal cell, respectively. The gate driving circuit 40 is connected to the gate line 12 and the data driving circuit 42 is connected to the data line 24. The gate driving circuit 40 sequentially applies a gate signal to the gate line 12. The gate signal is transmitted to a gate electrode of the switching element “S.” While the gate signal is applied to the switching element “S,” a data signal of the data driving circuit 42 is supplied to the data line 24 and is transmitted to the pixel electrode 17 (of FIG. 1) through the switching element “S.” Since a common voltage is applied to the common electrode 18 (of FIG. 1), an electric field is generated due to a voltage difference between the pixel electrode 17 (of FIG. 1) and the common electrode 18 (of FIG. 1) and the liquid crystal molecules in the liquid crystal layer between the pixel electrode 17 (of FIG. 1) and the common electrode 18 (of FIG. 1) are re-aligned along the electric field. As a result, images are displayed by the LCD device.

In the LCD device, a switching element property and LCD display quality depend on the gate insulating layer. FIG. 3 is a cross-sectional view taken along a line “III-III” of FIG. 1. As shown FIG. 3, the TFT “T” is formed on the first substrate 22. The TFT “T” as a switching element includes a gate electrode 30 on the first substrate 22, a gate insulating layer “GI” on the gate electrode 30, a semiconductor layer 32 on the gate insulating layer “GI” and source and drain electrodes 34 and 36 on the semiconductor layer 32. The semiconductor layer 32 includes an active layer 32a and an ohmic contact layer 32b, and the source and drain electrodes 34 and 36 are spaced apart from each other. A passivation layer “PAS” is formed on the source and drain electrodes 34 and 36. In addition, a pixel electrode 17 connected to the drain electrode 36 is formed on the passivation layer “PAS” in the pixel region “P.”

The pixel electrode 17 extends to overlap the gate line 12. As a result, overlapped portions of the gate line 12 and the pixel electrode 17 are used as first and second capacitor electrodes, respectively, and the first and second capacitor electrodes constitute a storage capacitor “Cst” with the intervening gate insulating layer “GI” and the intervening passivation layer “PAS.” The gate insulating layer “GI” includes an inorganic insulating material such as silicon nitride (SiNx) having a dielectric constant within a range of about 6 to about 8.

The gate insulating layer of an inorganic insulating material is formed through a deposition step which has a relatively long process time. In addition, the gate insulating layer of an inorganic insulating material may be formed as double layer for improvement of electric property and thickness. As a result, process yield of the gate insulating layer of an inorganic insulating material is poor.

To solve the above problems of the gate insulating layer of an inorganic insulating material, a gate insulating layer of an organic insulating material has been suggested. However, since the gate insulating layer of an organic insulating material has a dielectric constant less than about 4, property of the TFT such as an ON current is deteriorated and a capacitance of the storage capacitor is reduced. The reduction of the capacitance of the storage capacitor causes increase of a pixel voltage variation ΔVp of the LCD device. The pixel voltage variation ΔVp, which may be referred to as a kickback voltage or a level shift voltage, causes deterioration of the LCD device such as a flicker and an image sticking. As a result, a display quality of the LCD device is deteriorated.

### SUMMARY OF THE INVENTION

Accordingly, the present invention is directed to an array substrate for a liquid crystal display device and a method of fabricating the array substrate that substantially obviate one or more of the problems due to limitations and disadvantages of the related art.

An advantage of the present invention is to provide an array substrate for a liquid crystal display device that includes an improved gate insulating layer and a method of fabricating the array substrate where a process yield is improved.

Another advantage of the present invention is to provide an array substrate for a liquid crystal display device where a property of a thin film transistor and a display quality are improved and a method of fabricating the array substrate.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an array substrate for a liquid crystal display device, comprising: a substrate; a gate electrode on the substrate; and a gate insulating layer including an organic matrix of an organic material and an additive that increases a dielectric constant of the gate insulating layer.

In another aspect of the present invention, a method of fabricating an array substrate for a liquid crystal display device, comprising: forming a gate line on a substrate; and coating a solvent including an inorganic material to form a gate insulating layer on the gate line.

In another aspect of the present invention, a method of fabricating an array substrate for a liquid crystal display device, comprising: forming a gate line on a substrate; and coating a solution including a nano-particle to form a gate insulating layer on the gate electrode.

In another aspect of the present invention, a method of fabricating an array substrate for a liquid crystal display device, comprising: forming a gate electrode on a substrate; coating a solvent including an inorganic material to form a gate insulating layer on the gate electrode; forming a semiconductor layer on the gate insulating layer over the gate electrode; forming source and drain electrodes on the semiconductor layer; forming a passivation layer on the source and drain electrodes; and forming a pixel electrode on the passivation layer, the pixel electrode contacting the drain electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is an exploded perspective view showing a liquid crystal display device according to the related art.

FIG. 2 is an equivalent circuit diagram representing a liquid crystal display device according to the related art.

FIG. 3 is a cross-sectional view taken along a line “III-III” of FIG. 1.

FIG. 4 is a schematic cross-sectional view showing a thin film transistor of an array substrate for a liquid crystal display device according to a first embodiment of the present invention.

FIGS. 5A and 5B are cross-sectional views showing a method of forming a gate insulating layer of an array substrate for a liquid crystal display device according to a first embodiment of the present invention.

FIG. 6 is a cross-sectional view showing a solution used for a gate insulating layer of an array substrate for a liquid crystal display device according to a second embodiment of the present invention.

FIGS. 7A to 7D are cross-sectional views showing a method of forming an array substrate for a liquid crystal display device according to an embodiment of the present invention.

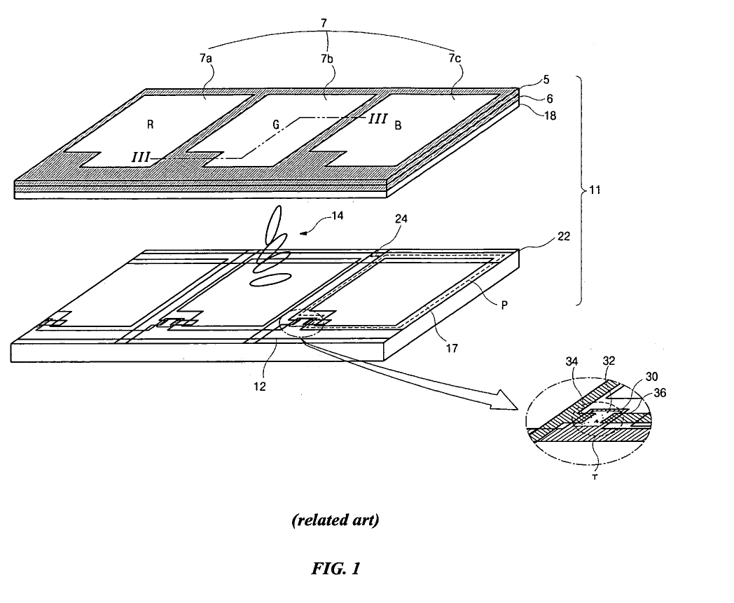

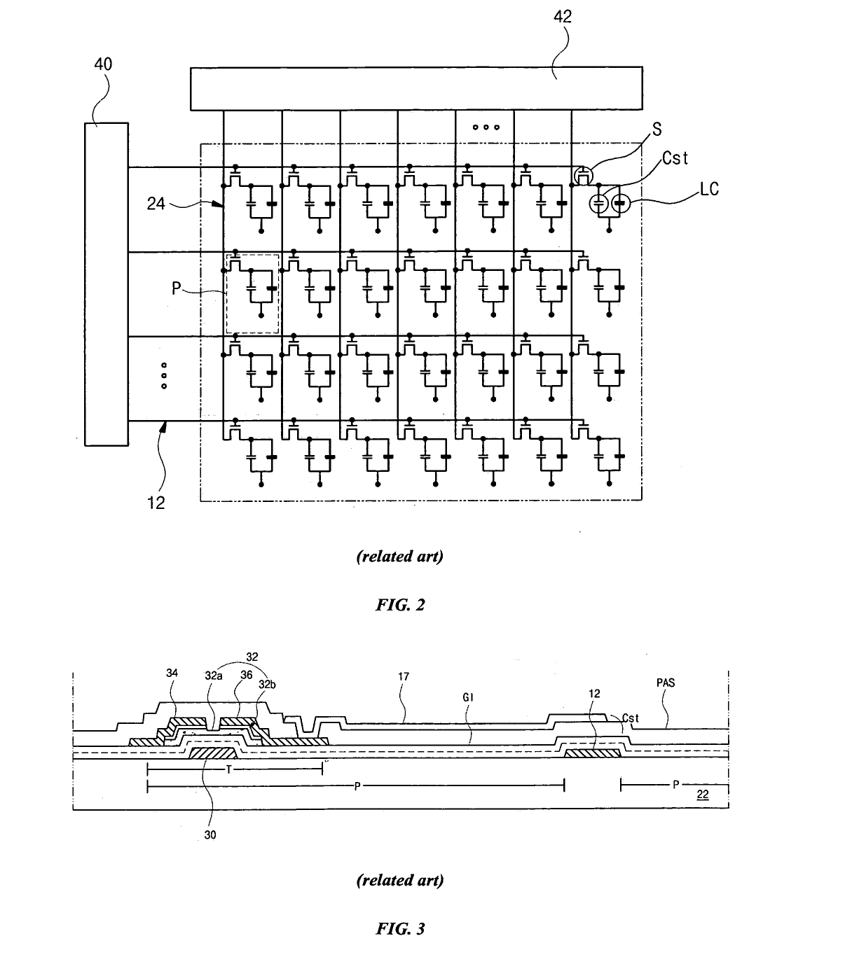

### DETAILED DESCRIPTION OF THE ILLUSTRATED EMBODIMENTS

Reference will now be made in detail to the exemplary embodiments of the present invention, examples of which are illustrated in the accompanying drawings. Wherever possible, similar reference numbers will be used to refer to the same or similar parts.

An array substrate for a liquid crystal display device according to the present invention includes a gate insulating layer benefiting a property of a thin film transistor and a display quality of the liquid crystal display device.

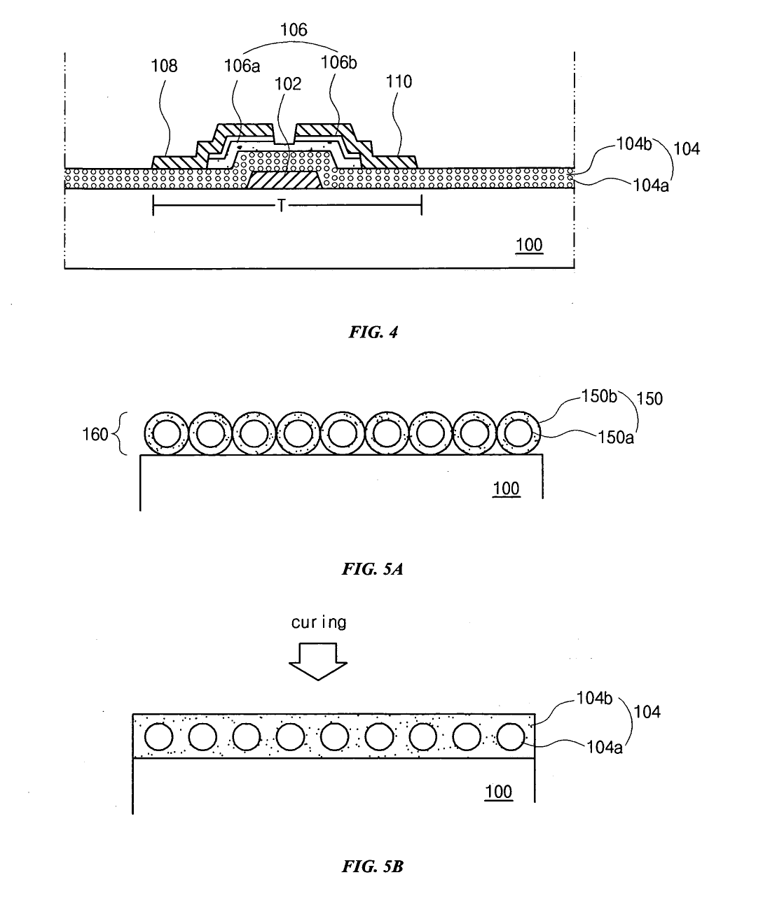

FIG. 4 is a schematic cross-sectional view showing a thin film transistor of an array substrate for a liquid crystal display device according to a first embodiment of the present invention.

In FIG. 4, a thin film transistor (TFT) “T” includes a gate electrode 102 on a substrate 100, a gate insulating layer 104 on the gate electrode 102, a semiconductor layer 106 on the gate insulating layer 104 over the gate electrode 102, and source and drain electrodes 108 and 110 on the semiconductor layer 106. The gate insulating layer 104 may include a particle and a matrix, preferably a nano-particle 104a of an inorganic material and an organic matrix 104b of an organic material. The organic matrix 104b surrounds the nano-particle 104a and the nano-particle 104a is dispersed in the organic matrix 104b. The gate insulating layer 104 may be obtained through steps of forming a composite precursor film of a core-shell structure and curing the composite precursor film by, for example, heat or light. In addition, an active layer may include an active layer 106a of intrinsic amorphous silicon and an ohmic contact layer 106b of impurity-doped amorphous silicon. The source and drain electrodes 108 and 110 are shown as spaced apart from each other.

Since the gate insulating layer 104 preferably has a dielectric constant greater than about 6, for example within a range of about 6 to about 10, a property of the TFT “T” is improved and a pixel voltage variation ΔVp of the LCD device is reduced. The pixel voltage variation ΔVp may be expressed as an equation (1).

ΔVp=Cgd·(Vgh−Vgl)/(Cst+Cgd+C_{LC}) (1)

where Cgd is a capacitance between the gate electrode 102 and the drain electrode 110, Cst is a capacitance of the storage capacitor, C_{LC} is a capacitance of the liquid crystal layer, Vgh is a high level voltage of a gate signal and Vgl is a low level voltage of the gate signal.

Since the storage capacitor includes the gate insulating layer 104 as a dielectric layer between the pixel electrode (not shown) and the common electrode (not shown), the capacitance Cst of the storage capacitor increases as the dielectric constant of the gate insulating layer 104 increases. In addition, as the capacitance Cst of the storage capacitor increases, the pixel voltage variation ΔVp decreases according to the equation (1). Even though the capacitance Csd also increases according to increase of the dielectric constant of the gate insulating layer 104, the pixel voltage variation ΔVp does not increase because the capacitance Csd is negligibly smaller than the capacitance Cst. As a result, the pixel voltage variation ΔVp is reduced and the display quality is improved due to the gate insulating layer 104 including the nano-particle 104a and the organic matrix 104b.

Further, when a gate signal is applied to the gate electrode 102 of the TFT “T” having an inverted staggered structure, a channel is promptly generated in the semiconductor layer 106 due to the gate insulating layer 104. Accordingly, a property of the TFT “T” is improved.

Moreover, since the gate insulating layer 104 may be coated on the gate electrode 104, a forming step of the gate insulating layer 104 is simplified and a thickness uniformity is improved. As a result, a property of the TFT “T” is further improved.

FIGS. 5A and 5B are cross-sectional views showing a method of forming a gate insulating layer of an array substrate for a liquid crystal display device according to a first embodiment of the present invention.

In FIG. 5A, a coating, for example a composite precursor film 160, is formed on a substrate 100 by a coating method. The composite precursor film 160 may include particles 150 each having a core-shell structure of a core 150a and a shell 150b surrounding the core 150a. The core 150a may include an inorganic material and the shell 150b may include an organic material. The composite precursor film 160 may have a dielectric constant over about 12. The core 150a may be fabricated through a polymerization method of an additive such as a sol-gel method. In addition, the core 150a may include one of barium strontium titanate, barium zirconate titanate, lead zirconate titanate, strontium titanate, barium titanate, barium magnesium fluoride, bismuth titanate, strontium bismuth tantalate, strontium bismuth tantalate niobate and a metal oxide material such as zirconium oxide (ZrO₂), aluminum oxide (Al₂O₃), magnesium oxide (MgO), calcium oxide (CaO), zirconium silicate (ZrSiO₄), hafnium silicate (HfSiO₄), yttrium oxide (Y₂O₃), hafnium oxide (HfO₂), strontium oxide (SrO), lanthanum oxide (La₂O₃), tantalum oxide (Ta₂O₅), barium oxide (BaO) and titanium oxide (TiO₂). After particles having the core-shell structure are dispersed in a solvent, the solvent is coated on the substrate 100.

In FIG. 5B, the coating 160 (of FIG. 5A) may be cured, for example, by one of heat and light. If the solvent is evaporated and the shell 150b melts during the curing step, the composite precursor film 160 (of FIG. 5A) is planarized to become the gate insulating layer 104 preferably including a nano-particle 104a and an organic matrix 104b surrounding the nano-particle 104a. The nano-particle 104a and the organic matrix 104b may correspond to the core 150a and the shell 150b, respectively. As a result, the gate insulating layer 104 may have a dielectric constant within a range of about 6 to about 10.

In the array substrate according to the first embodiment of the present invention, the gate insulating layer having a relatively high dielectric constant may be formed using a composite precursor film including particles having a core-shell structure. In an array substrate according to another embodiment, a gate insulating layer may be formed by coating an organic polymer solution where nano-particles are dispersed.

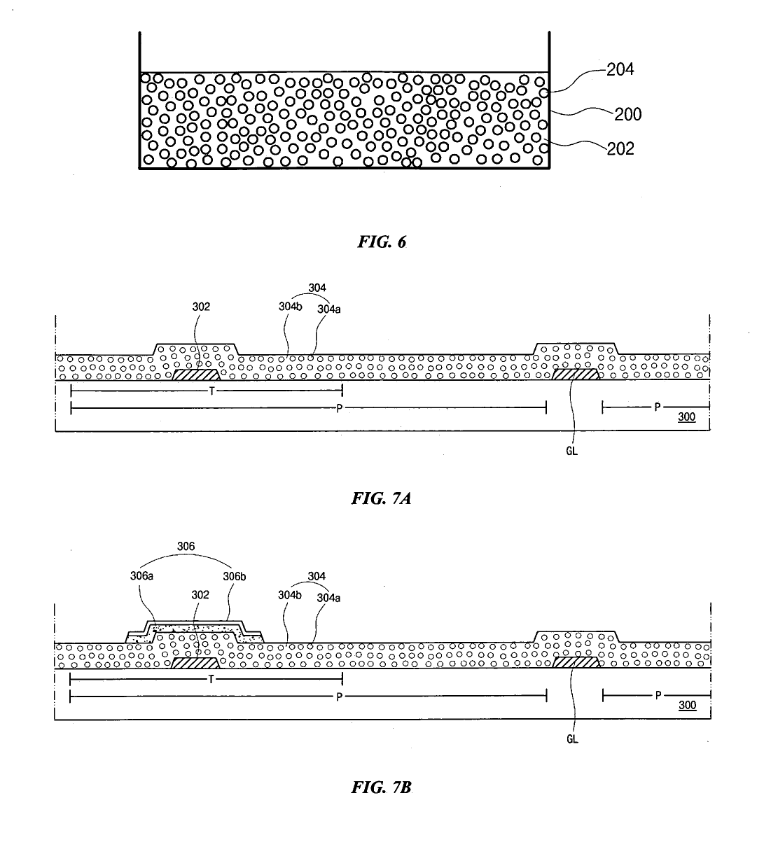

FIG. 6 is a cross-sectional view showing an organic polymer solution used for a gate insulating layer of an array substrate for a liquid crystal display device according to a second embodiment of the present invention.

In FIG. 6, an organic polymer melts in a solvent to constitute an organic polymer solution 202 in a vessel 200. A particle, preferably a nano-particle 204 such as zirconium oxide (ZrO₂) having a dielectric constant over about 8 may be dispersed in the organic polymer solution 202. The organic polymer may include a material obtainable through a sol-gel method. For example, the organic polymer may include one of single polymer and copolymer such as siloxane polymer, polyacrylate-polyimide and polyester. In addition, the nano-particle 204 may include one of barium strontium titanate, barium zirconate titanate, lead zirconate titanate, strontium titanate, barium titanate, barium magnesium fluoride, bismuth titanate, strontium bismuth tantalate, strontium bismuth tantalate niobate and a metal oxide material such as zirconium oxide (ZrO₂), aluminum oxide (Al₂O₃), magnesium oxide (MgO), calcium oxide (CaO), zirconium silicate (ZrSiO₄), hafnium silicate (HfSiO₄), yttrium oxide (Y₂O₃), hafnium oxide (HfO₂), strontium oxide (SrO), lanthanum oxide (La₂O₃), tantalum oxide (Ta₂O₅), barium oxide (BaO) and titanium oxide (TiO₂)

The nano-particle 204 may be dispersed in the organic polymer solution 202 using one of a physical force and a chemical force. The organic polymer solution 202 having the nano-particle 204 may be stirred using a shear force in a dispersion step using a physical force, while a chemical bond may be induced in a dispersion step using a chemical force. After the organic polymer solution 202 where the nano-particle 204 is dispersed is prepared, a gate insulating layer having a dielectric constant within a range of about 6 to about 10 is formed on a substrate having a gate electrode by coating the organic polymer solution 202 having the nano-particle 204. The gate insulating layer may include an organic matrix and a nano-particle corresponding to the organic polymer and the nano-particle of the organic polymer solution 202, respectively.

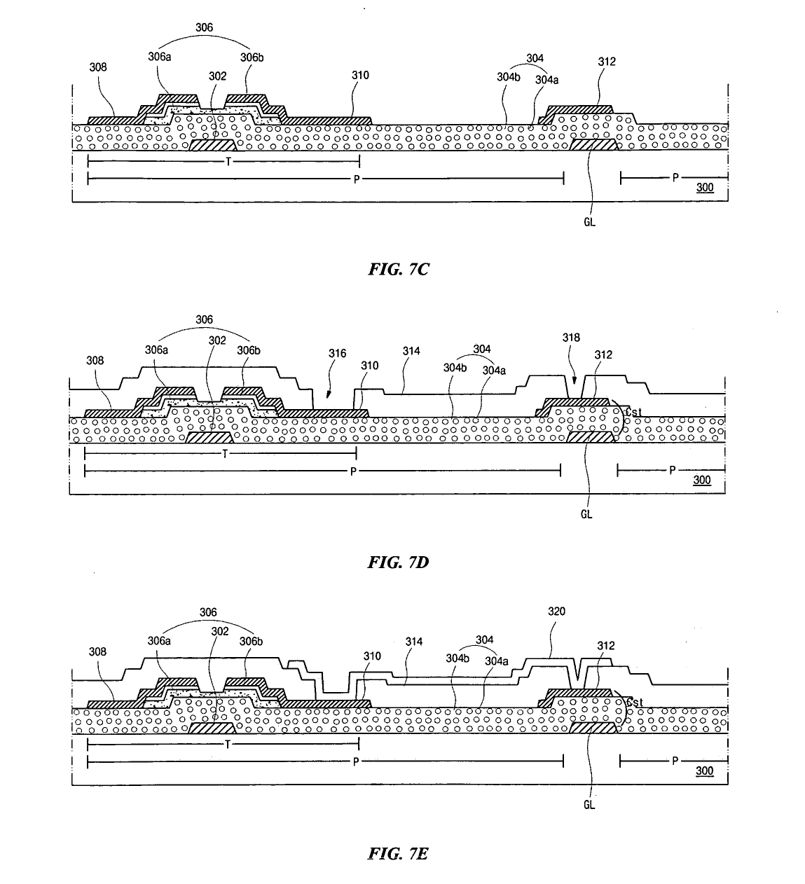

FIGS. 7A to 7D are cross-sectional views showing a method of forming an array substrate for a liquid crystal display device according to an embodiment of the present invention.

In FIG. 7A, a gate electrode 302 and a gate line “GL” connected to the gate electrode 302 are formed on a substrate 300 by depositing and patterning a metallic material such as aluminum (Al), aluminum (Al) alloy, chromium (Cr), copper (Cu), titanium (Ti), tungsten (W) and molybdenum (Mo). A gate insulating layer 304 is formed on the gate electrode 302 and the gate line “GL.” The gate insulating layer 304 includes a nano-particle 304a and an organic matrix 304b surrounding the nano-particle 304a.

As illustrated in the first embodiment, the gate insulating layer 304 may be formed using a composite precursor film. The composite precursor film may be formed on the gate electrode 302 and the gate line “GL” by coating and curing a solvent having particles each having a core-shell structure of a core and a shell. If the solvent is evaporated and the shell melts during the curing step, a gate insulating layer 304 including the nano-particle 304a and the organic matrix 304b may be formed on the gate electrode 302 and the gate line “GL.” The nano-particle 304a and the organic matrix 304b correspond to the core and shell, respectively.

In addition, as illustrated in the second embodiment, the gate insulating layer 304 may be formed using an organic polymer solution where a nano-particle such as zirconium oxide (ZrO₂) is dispersed. The gate insulating layer 304 may be formed by coating the organic polymer solution including an organic polymer and a nano-particle on the gate electrode 302 and the gate line “GL.” The nano-particle 304a and the organic matrix 304b correspond to the nano-particle and the organic polymer of the organic polymer solution, respectively.

Since the gate insulating layer 304 may have a dielectric constant within a range of about 6 and about 10, a capacitance of the storage capacitor increases and a pixel voltage variation is reduced. As a result, a display quality of the LCD device is improved. Further, a property of the TFT such as a response time is improved. Moreover, since the gate insulating layer 304 is formed using a coating method instead of a deposition method, a fabrication process is simplified.

In FIG. 7B, a semiconductor layer 306 may be formed on the gate insulating layer 304 by sequentially depositing and patterning intrinsic amorphous silicon (a-Si:H) and impurity-doped amorphous silicon (n+a-Si:H). The semiconductor layer 306 includes an active layer 306a of the amorphous silicon (a-Si:H) and an ohmic contact layer 306b of the impurity-doped amorphous silicon (n+a-Si:H).

In FIG. 7C, source and drain electrodes 308 and 310 may be formed on the semiconductor layer 306 by coating and patterning at least one of a metallic material such as aluminum (Al), aluminum (Al) alloy, chromium (Cr), copper (Cu), titanium (Ti), tungsten (W) and molybdenum (Mo). A data line (not shown) may be simultaneously formed on the substrate 300 having the semiconductor layer 306. The source and drain electrodes 308 and 310 are spaced apart form each other, and the data line crosses the gate line “GL” to define a pixel region “P.” In addition, a metal pattern 312 having an island shape may be formed on the gate insulating layer 304 over the gate line “GL” simultaneously. Accordingly, a portion of the gate line “GL” and the metal pattern 312 function as first and second capacitor electrodes to form a storage capacitor “Cst” with the gate insulating layer 304. Subsequently, the ohmic contact layer 306b exposed between the source and drain electrodes 308 and 310 may be removed to expose the active layer 306a.

In FIG. 7D, a passivation layer 314 having a drain contact hole 316 and a storage contact hole 318 may be formed on the source electrode 308, the drain electrode 310, the data line and the metal pattern 312 by depositing and patterning an organic insulating material such as benzocyclobutene (BCB) and acrylic resin. The drain contact hole 316 and the storage contact hole 318 expose the drain electrode 310 and the metal pattern 312, respectively.

In FIG. 7E, a pixel electrode 320 may be formed on the passivation layer 314 in the pixel region “P” by depositing and patterning one of indium-tin-oxide (ITO) and indium-zinc-oxide (IZO). The pixel electrode 320 is connected to the drain electrode 310 through the drain contact hole 316 and the metal pattern 312 through the storage contact hole 318. The pixel electrode 320 may be contacted with the drain electrode 310 and metal pattern 312 directly or indirectly via an intervening layer. The array substrate for an LCD device including the gate insulating layer having a relatively high dielectric constant is completed through process shown in FIGS. 7A to 7E.

Consequently, in the present invention, since a gate insulating layer having a relatively high dielectric constant may be formed using a composite precursor film or an organic polymer solution through a coating method instead of a deposition method, a fabrication process is simplified and a production yield is improved. In addition, since the gate insulating layer may have a relatively high dielectric constant and a planar surface, a property of a thin film transistor is improved. Further, since a pixel voltage variation is reduced, a display quality of an LCD device is improved.

It will be apparent to those skilled in the art that various modifications and variations can be made in an array substrate for a liquid crystal display device and a method of fabricating the array substrate of the present invention without departing from the spirit or scope of the invention. Thus, it is intended that the present invention cover the modifications and variations of this invention provided they come within the scope of the appended claims and their equivalents.

What is claimed is:

1. An array substrate for a liquid crystal display device, comprising:
a substrate;
a gate electrode on the substrate; and
a gate insulating layer including an organic matrix of an organic material and an additive that increases a dielectric constant of the gate insulating layer.

2. The array substrate according to claim 1, wherein the gate insulating layer has a dielectric constant greater than about 6.

3. The array substrate according to claim 1, wherein the organic matrix includes siloxane polymer, polyacrylate-polyimide or polyester.

4. The array substrate according to claim 1, further comprising:
a semiconductor layer on the gate insulating layer over the gate electrode;
source and drain electrodes on the semiconductor layer;
a passivation layer on the source and drain electrodes; and
a pixel electrode on the passivation layer, the pixel electrode contacting the drain electrode,
wherein the gate insulating layer is on the gate electrode,
wherein the additive includes a nano-particle of an inorganic material,
wherein the organic matrix surrounds the nano-particle.

5. The array substrate according to claim 4, wherein the nano-particle includes barium strontium titanate, barium zirconate titanate, lead zirconate titanate, strontium titanate, barium titanate, barium magnesium fluoride, bismuth titanate, strontium bismuth tantalate, strontium bismuth tantalate niobate, zirconium oxide (ZrO₂), aluminum oxide (Al₂O₃), magnesium oxide (MgO), calcium oxide (CaO), zirconium silicate (ZrSiO₄), hafnium silicate (HfSiO₄), yttrium oxide (Y₂O₃), hafnium oxide (HfO₂), strontium oxide (SrO), lanthanum oxide (La₂O₃), tantalum oxide (Ta₂O₅), barium oxide (BaO) or titanium oxide (TiO₂).

6. The array substrate according to claim 4, further comprising:
a gate line connected to the gate electrode;
a data line connected to the source electrode, wherein the data line crosses the gate line; and
a metal pattern over the gate line between the gate insulating layer and the passivation layer, wherein the pixel electrode contacts the metal pattern, and wherein the metal pattern, the gate line and the gate insulating layer constitute a storage capacitor.

7. A method of fabricating an array substrate for a liquid crystal display device, comprising:
forming a gate line on a substrate; and
coating a solvent including an inorganic material to form a gate insulating layer on the gate line.

8. The method according to claim 7, wherein the gate insulating layer has a dielectric constant greater than about 6.

9. The method according to claim 7, wherein the inorganic material includes barium strontium titanate, barium zirconate titanate, lead zirconate titanate, strontium titanate, barium titanate, barium magnesium fluoride, bismuth titanate, strontium bismuth tantalate, strontium bismuth tantalate niobate, zirconium oxide (ZrO₂), aluminum oxide (Al₂O₃), magnesium oxide (MgO), calcium oxide (CaO), zirconium silicate (ZrSiO₄), hafnium silicate (HfSiO₄), yttrium oxide (Y₂O₃), hafnium oxide (HfO₂), strontium oxide (SrO), lanthanum oxide (La₂O₃), tantalum oxide (Ta₂O₅), barium oxide (BaO) or titanium oxide (TiO₂).

10. The method according to claim 7, further comprising:
forming a composite precursor film including a particle having a core and a shell surrounding the core on the gate line by the coating step, the core including the inorganic material and the shell including an organic material;
forming the gate insulating layer by curing the composite precursor film, the gate insulating layer including a nano-particle and an organic matrix surrounding the nano-particle, the nano-particle and the organic matrix corresponding to the core and the shell, respectively;
forming a semiconductor layer on the gate insulating layer over a gate electrode;
forming source and drain electrodes on the semiconductor layer;
forming a passivation layer on the source and drain electrodes; and
forming a pixel electrode on the passivation layer, the pixel electrode contacting the drain electrode.

11. The method according to claim 10, wherein curing the composite precursor film includes melting the shell to planarize the composite precursor.

12. The method according to claim 10, further comprising:
forming a gate line connected to the gate electrode;
forming a data line connected to the source electrode and crossing the gate line; and
forming a metal pattern over the gate line between the gate insulating layer and the passivation layer, wherein the pixel electrode contacts the metal pattern, and wherein the metal pattern, the gate line and the gate insulating layer constitute a storage capacitor.

13. A method of fabricating an array substrate for a liquid crystal display device, comprising:
forming a gate line on a substrate; and
coating a solution including a nano-particle to form a gate insulating layer on the gate electrode.

14. The method according to claim 13, wherein the gate insulating layer has a dielectric constant greater than about 6.

15. The method according to claim 13, wherein the nano-particle includes barium strontium titanate, barium zirconate titanate, lead zirconate titanate, strontium titanate, barium titanate, barium magnesium fluoride, bismuth titanate, strontium bismuth tantalate, strontium bismuth tantalate niobate, zirconium oxide (ZrO₂), aluminum oxide (Al₂O₃), magnesium oxide (MgO), calcium oxide (CaO), zirconium silicate (ZrSiO₄), hafnium silicate (HfSiO₄), yttrium oxide (Y₂O₃), hafnium oxide (HfO₂), strontium oxide (SrO), lanthanum oxide (La₂O₃), tantalum oxide (Ta₂O₅), barium oxide (BaO) or titanium oxide (TiO₂).

16. The method according to claim 13, further comprising:
forming a semiconductor layer on the gate insulating layer over the gate electrode;
forming source and drain electrodes on the semiconductor layer;
forming a passivation layer on the source and drain electrodes; and
forming a pixel electrode on the passivation layer, the pixel electrode contacting the drain electrode,
wherein the solution includes an organic polymer solution having an organic polymer, wherein the gate insulating layer includes the nano-particle and an organic matrix surrounding the nano-particle and corresponding to the organic polymer.

17. The method according to claim 16, wherein the organic polymer includes siloxane polymer, polyacrylate-polyimide or polyester.

18. The method according to claim 16, further comprising:
forming a gate line connected to the gate electrode;
forming a data line connected to the source electrode and crossing the gate line; and
forming a metal pattern over the gate line between the gate insulating layer and the passivation layer, wherein the pixel electrode contacts the metal pattern, and wherein the metal pattern, the gate line and the gate insulating layer constitute a storage capacitor.

19. The method according to claim 16, wherein the nano-particle is dispersed in the organic polymer solution using one of a physical force and a chemical force.

20. A method of fabricating an array substrate for a liquid crystal display device, comprising:
forming a gate electrode on a substrate;
coating a solvent including an inorganic material to form a gate insulating layer on the gate electrode;
forming a semiconductor layer on the gate insulating layer over the gate electrode;
forming source and drain electrodes on the semiconductor layer;
forming a passivation layer on the source and drain electrodes; and
forming a pixel electrode on the passivation layer, the pixel electrode contacting the drain electrode.
